(19) United States
(12) Patent Application Publication
(10) Pub. No.: US 2006/0182393 A1
(43) Pub. Date: Aug. 17, 2006

(54) System for confined optical power delivery and enhanced optical transmission efficiency

(75) Inventors: Ibrahim Kursat Sendur, Pittsburgh, PA (US); Chubing Peng, Pittsburgh, PA (US)

Correspondence Address: Benjamin T. Queen, II;Pietragallo, Bosick & Gordon, One Oxford Centre, 38th Floor, 301 Grant Street, Pittsburgh, PA, 15219, US

(73) Assignee: Seagate Technology LLC, Scotts Valley, CA (US)

(21) Appl. No.: 11/055,864

(22) Filed: Feb. 11, 2005

(51) Int. Cl. G02B 6/26

(52) U.S. Cl. 385/39

(57) ABSTRACT

A system for confined optical power delivery and enhanced optical transmission efficiency includes a waveguide defining an aperture, a focusing element, and a coupling layer positioned between the waveguide and the focusing element. The waveguide may be, for example, in the form of a ridge waveguide. The focusing element is formed of a material having a refractive index that is greater than a refractive index of the coupling layer. The focusing element may be, for example, a solid immersion lens or a solid immersion mirror.

### STATEMENT REGARDING FEDERALLY SPONSORED RESEARCH OR DEVELOPMENT

This invention was made with United States Government support under Agreement No. 70NANB1H3056 awarded by the National Institute of Standards and Technology (NIST). The United States Government has certain rights in the invention.

### FIELD OF THE INVENTION

The invention relates to a system for confined optical power delivery and enhanced optical transmission efficiency.

### BACKGROUND INFORMATION

A variety of applications, such as imaging, lithography, and data storage require intense optical spots of energy beyond the diffraction limit. Advances in near field optics achieve spatial resolution significantly better than the diffraction limit. Solid immersion lenses, apertures on metallic conductors, bowtie antennas, tapered optical fibers and silicon pyramidal probes are among the possible ways to achieve intense optical spots with sufficiently small sizes.

Within the field of data storage, heat assisted magnetic recording (HAMR) is a potential technique to extend the physical limits of conventional magnetic recording techniques, which are restrained by the super paramagnetic effect. In a HAMR system, high temperatures with large gradients are used to reduce the coercivity of the recording media. After heating the medium close to its Curie point, an external magnetic field is used to record data in the medium. Optical absorption profiles with high intensity and narrow extent are required to achieve such thermal spots. However, known optical transducer systems and configurations are not capable of producing such optical absorption profiles in the media. For example, known systems and configurations fail to provide either high intensities or narrow absorption profiles in the media.

Accordingly, there is a need for new and improved optical transducer systems and configurations capable of providing the necessary high intensities and narrow absorption profiles for generating intense optical spots with sufficiently small sizes to meet the demands of applications which require such optical spots.

### SUMMARY OF THE INVENTION

An aspect of the present invention is to provide a system comprising a waveguide defining an aperture, a focusing element and a coupling layer positioned between the waveguide and the focusing element. The focusing element is formed of a material having a first refractive index and the coupling layer is formed of a material having a second refractive index. The second refractive index of the coupling layer is less than the first refractive index of the focusing element. The focusing element may be, for example, a solid immersion lens or a solid immersion mirror. The waveguide may have an asymmetric charge distribution across the aperture.

Another aspect of the present invention is to provide a system comprising a waveguide including a ridge and defining an aperture through the waveguide, a focusing element, and a coupling layer positioned between the waveguide and the focusing element wherein the coupling layer has a refractive index less than a refractive index of the focusing element.

A further aspect of the present invention is to provide a data storage system comprising a storage media and a recording device positioned adjacent to the storage media. The recording device includes a waveguide defining an aperture. The recording device further includes a focusing element having a first refractive index and a coupling layer that is positioned between the waveguide and the focusing element, wherein the coupling layer has a second refractive index that is less than the first refractive index of the focusing element.

These and other aspects of the present invention will be more apparent from the following description.

### BRIEF DESCRIPTION OF THE DRAWINGS

FIG. 1 is a pictorial representation of a typical disc drive that can utilize optical systems and configurations constructed in accordance with the present invention.

FIG. 2 is a schematic illustration of a system constructed in accordance with an embodiment of the present invention.

FIG. 3 is a schematic illustration of a system constructed in accordance with another embodiment of the present invention.

FIG. 4 is a schematic illustration of a ridge waveguide that can be utilized with the present invention.

FIG. 5 is a graphical illustration of power density versus low index coupling layer material thickness for an embodiment of the invention.

### DETAILED DESCRIPTION

The invention relates to a system for confined optical power delivery and enhanced optical transmission efficiency. The invention encompasses systems that can be used to produce small, intense optical spots. The invention has utility in a variety of applications such as, for example, data storage, imaging, lithography, high resolution optical microscopy, integrated opto-electronic devices for telecommunications or other applications that may require the generation and use of small, intense optical spots of energy.

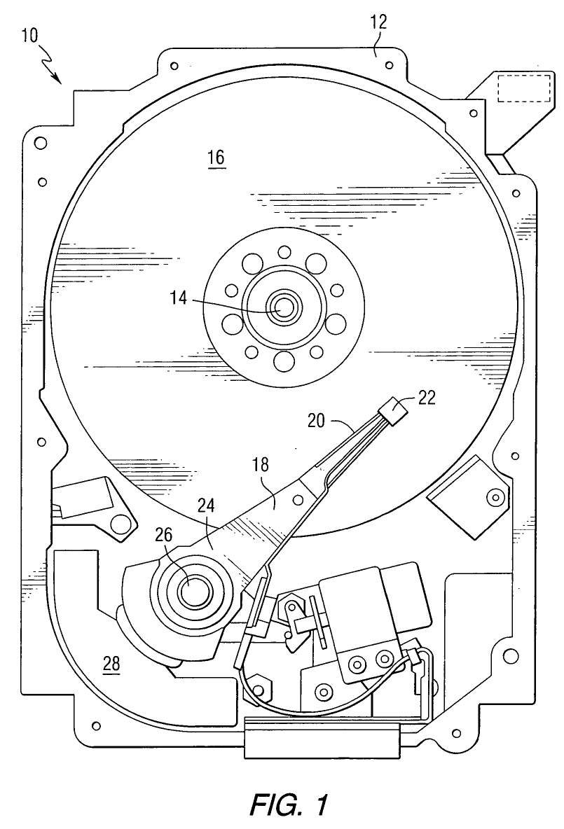

Within the specific field of data storage, the invention encompasses systems that can be used in recording devices for use with various types of data storage media. FIG. 1 is a pictorial representation of a typical disc drive 10 that can utilize optical systems and configurations constructed in accordance with the present invention. The disc drive includes a housing 12 (with the upper portion removed and the lower portion visible in this view) sized and configured to contain the various components of the disc drive. The disc drive includes a spindle motor 14 for rotating at least one data storage medium 16 with the housing 12. At least one arm 18 is contained within the housing 12 with each arm 18 having a first end 20 with a recording and reading head or slider 22, and a second end 24 pivotally mounted on a shaft by a bearing 26. An actuator motor 28 is located at the arm's second end 24 for pivoting the arm 18 to position the head 22 over a desired sector of the disc 16. The actuator motor 28 is regulated by a controller that is not shown in this view and is, however, well known in the art.

While the invention may have numerous applications in various technologies as described herein, one specific area of data storage, heat assisted magnetic recording (HAMR), will be used herein to illustrate and describe example embodiments of the invention. Generally, HAMR is a potential technique to extend the physical limits of conventional data storage recording techniques, which are known to be restrained by the super paramagnetic effect. In a HAMR system, high temperatures with large gradients are used to reduce the coercivity of the recording medium. Optical absorption profiles with high intensity and narrow extent are required to achieve small and intense optical spots of energy. However, known optical transducer configurations and systems do not satisfactorily produce such optical absorption profiles in the recording medium. For example, known arrangements typically fail to provide either high intensities or narrow absorption profiles in the recording medium. To achieve the desired transmission efficiencies, the present invention takes into consideration surface plasmon and geometric resonances at optical frequencies, which can be efficiently optimized for obtaining the desired transmission efficiencies. Furthermore, the present invention contemplates near field transducers being integrated with surface plasmon enhancing configurations, as will be discussed in more detail herein.

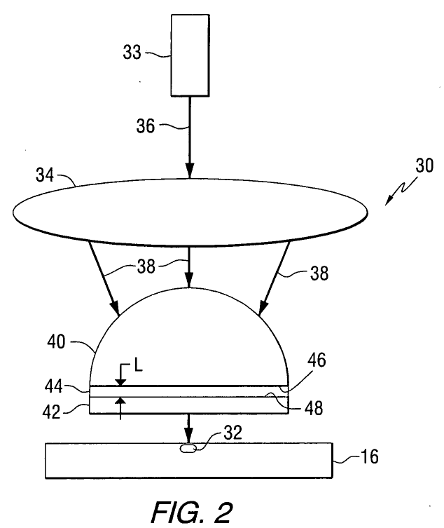

Referring to FIG. 2, there is illustrated a system 30 for producing higher transmissions efficiencies for the generation of a small, intense optical spot 32 on the recording medium 16. Specifically, the system 30 may include an optical source of energy 33 for directing electromagnetic radiation, as illustrated at 36, toward a focusing element such as, for example, an optical lens 34. The optical source 33 is used for producing the required electromagnetic waves to excite the near-field transducer. The optical source 33 may produce electromagnetic waves in the visible, infrared, or ultraviolet regions of the electromagnetic spectrum. The optical source 33 may be a laser such as, for example, a solid state laser or a semiconductor laser. The optical lens 34 may be a two-dimensional or three-dimensional lens system. An example of an optical lens 34 for use with the invention is a two-dimensional optical waveguide with mode index waveguide lenses.

The optical lens 34 serves as a means for concentrating the electromagnetic radiation 36 from the optical source 33. The optical lens 34 then focuses the electromagnetic radiation, as illustrated at 38, toward a focusing element such as, for example, a solid immersion lens (SIL) 40. The SIL 40 is used to further concentrate the electromagnetic waves into smaller spots. The minimum spot size that can be obtained from objective lenses is limited by the well-known diffraction limit. The focused spot size that can be obtained from a lens is proportional to the wavelength, and inversely proportional to the numerical aperture (NA) of the lens. The spot size can be reduced by increasing the index of refraction of the medium in which the light is focused, which increases the NA of the lens. SIL 40, in which the light is focused in a high refractive index solid, can achieve smaller optical spots than the conventional diffraction limit of objective lenses. Increasing the NA using a SIL increases the electric field at the focal region. Placing a near-field transducer in the proximity of such enhanced electric fields increases the near-field radiation from the transducer as well. In this embodiment, we achieve better near-field radiation of an optical system by increasing its NA using the SIL 40. One of the key parameters of the SIL 40 is the refractive index of the material from which the SIL 40 is made. In order to achieve smaller optical spots and higher incident electromagnetic radiation over the transducer, the refractive index of the transparent material should be as high as possible. Examples of high index materials suitable for forming the SIL 40 include, for example, TiO₂, Ta₂O₅, and GaP.

Still referring to FIG. 2, the system 30 may also include a waveguide, i.e. a transducer, such as, for example, a ridge waveguide 42 (see also FIG. 4) and a coupling layer 44 positioned between the SIL 40 and the ridge waveguide 42. The coupling layer 44 includes a first surface 46 that may or may not be in contact with the SIL 40. The coupling layer 44 may also have a second surface 48 that may or may not be in contact with the ridge waveguide 42. In addition, the coupling layer 44 may have a thickness L in the range of about 5 nm to about 100 nm. The coupling layer 44 may include a layer of air (vacuum) or may be formed of a material such as, for example, MgF₂, Al₂O₃, SiO₂ or SiN. The coupling layer 44 should have a lower refractive index compared to the material of the SIL 40 or other types of focusing elements that may be used with the invention. The high-index low-index boundary will cause a total internal reflection of the electromagnetic waves, and will create evanescent fields. These evanescent fields are important to improve the coupling efficiency of the near field system. They will couple into surface plasmon modes over the metallic transducer, i.e., the waveguide 42, and will improve the transmission efficiency.

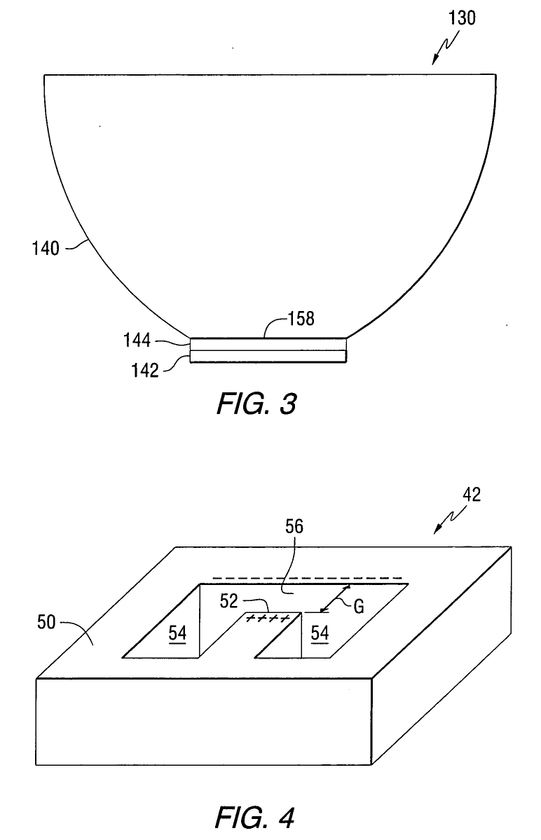

Referring to FIG. 3, there is illustrated an additional embodiment of a system 130 constructed in accordance with the invention. The system 130 includes a solid immersion mirror (SIM) 140 as opposed to the SIL 40 illustrated in FIG. 2. The system 130 also includes a focusing element such as, for example, a ridge waveguide 142 and a coupling layer 144 positioned between the SIM 140 and the ridge waveguide 142. The system 130 otherwise is similar in construction and operates in a similar manner as the system 30 illustrated in FIG. 2 and described herein. The SIM 40 may be made of high-refractive index transparent material and may have side edge surfaces of substantially parabolic shape. The edges having the parabolic shape will focus the light to the focal point of the SIM 140. Other shapes can also be used depending on the characteristics of the incoming electromagnetic wave. Focused light, which may be, for example, linearly polarized light, is most suitable for exciting the waveguide 142.

The system configurations 30 and 130 illustrated in FIGS. 2 and 3, respectively, may be constructed wherein the SIL 40 and the SIM 140 may be either three dimensional or two dimensional planar constructions. These can be, for example, mode index waveguide lenses or a parabolic-mirror in planar waveguides. In the latter case, the edges of the waveguide mirror can be substantially parabolic in shape, although depending on the incident beam the shape can be altered to focus the electromagnetic radiation in the focal region.

Referring to FIG. 4, an embodiment of the ridge waveguide 42 is illustrated. The ridge waveguide 42 also includes a ridge 52 that defines an aperture 54 that extends through the ridge waveguide 42. The ridge 52 is positioned a distance G from an opposing side 56 of the ridge waveguide 42. The waveguide 42 can be made of, for example, Ag, Au, Al or Cu.

In operation of the waveguide 42, incident optical power (i.e. an electromagnetic wave) induces currents over the surface of a metallic film used to form the waveguide 42. The induced current over the metallic film creates charge distribution over the ridge 52 (as illustrated by the “+” charge symbols) of the waveguide 42 and the opposite side 56 (as illustrated by the “−” charge symbols) across the gap distance G. Due to the asymmetric nature of the waveguide 42 geometry, the accumulated charge distribution on the ridge 52 of the waveguide 42 and the opposite side 56 are not symmetric. This asymmetric charge distribution with reverse polarities re-radiate as an electric dipole, creating a localized near field radiation. The charge distribution over the ridge 52 is smaller, however, stronger compared to the charge distribution over the opposite side 56. Therefore, the re-radiated electromagnetic field is also asymmetric. This asymmetric radiation creates a smaller optical spot. Accordingly, waveguide 42 can be interpreted as an aperture that produces asymmetric charge distribution with reverse polarities on the ridge 52 and the opposite side 56. The localized charge distributions with reverse polarities acts as an electric dipole, which produces a localized near-field radiation for generating an optical spot, such as optical spot 32 on the media 16 as illustrated in FIG. 2.

Referring to FIG. 2, the coupling layer 44 has been described as positioned between the SIL 40 and the ridge waveguide 42 (or in the case of the embodiment illustrated in FIG. 3, the coupling layer 144 is positioned between the SIM 140 and the ridge waveguide 142). In accordance with an aspect of the invention, the SIL 40 is formed of a material having a first refractive index while the coupling layer is formed of a material having a second refractive index wherein the first refractive index of the SIL 40 is greater than the second refractive index of the coupling layer 44. Similarly, the SIM 140 is formed of a material having a refractive index that is greater than a refractive index of the coupling layer 144. For example, the SIL 40 and/or the SIM 140 (or other type focusing element that may be used with the invention) may have a refractive index in the range of about 1.7 to about 4.0. In contrast, the coupling layer 44 or the coupling layer 144 may have a refractive index in the range of about 1.0 to about 2.0.

An advantage of positioning a higher refractive index SIL 40 or SIM 140 adjacent a lower refractive index coupling layer 44 or 144, respectively, is that total internal reflection occurs at the high index-low index material interface and evanescent waves are created. Evanescent wave coupling is the major source of enhancement of surface plasmon resonances. Surface plasmon modes can be optically excited in a metal film using the Otto excitation technique in which light is incident from a high refractive index material onto the metal film via a low index dielectric spacer. Due to the total internal reflection at the high-low index boundary, evanescent waves are created which couple efficiently into the surface plasmon modes over the metal film. By placing a low-index material, i.e., coupling layer 44 or 144, between the SIL 40 or the SIM 140 and the ridge waveguide 42 or 142, respectively, a similar effect can be obtained.

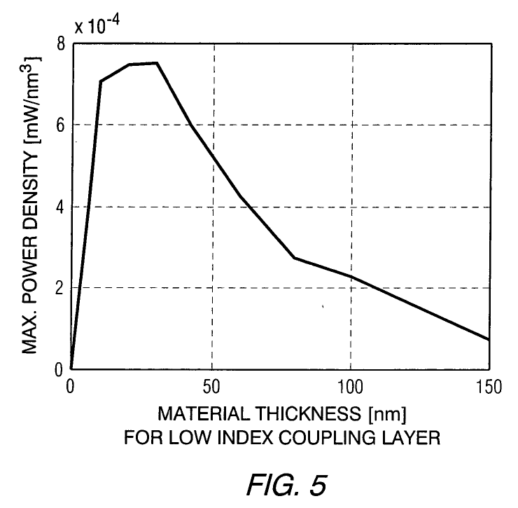

Analytical modeling results for a typical Otto configuration indicates that the optimum thickness for the low index dielectric spacer layer is in the range of 300 nm to 400 nm. In comparison, finite element modeling results for the systems 30 and 130 of the present invention indicate that an acceptable thickness range for the low index coupling layers 44 and 144 is in the range of about 5 nm to about 100 nm, with an optimum range of thickness being from about 20 nm to about 30 nm (see FIG. 5). Therefore, it will be appreciated that the power density obtained from the systems 30 and 130 of the present invention which utilize the ridge waveguide 42 and 142, respectively, allow for the use of a thinner low index coupling layer 44 and 144, respectively, in comparison to the low index layer that is necessary in a typical Otto configuration. Thus, use of the ridge waveguide is a primary reason for the enhancement in near field radiation for the generation of a small, intense optical spot in accordance with the present invention.

Collimated light, which has a single component in the k-spectrum, is used to excite surface plasmons in a typical Otto configuration. However, the focused light obtained from, for example, SIL 40 has a wide k-spectrum distribution. We have found that the difference of the results for a much thinner low index coupling layer of the present invention in comparison to the thicker low index material from a typical Otto configuration is due at least in part to the difference in the k-spectrum of the incident electric field. This result also points out that the interaction of surface plasmons in the optimum geometries to excite surface plasmons are different for collimated versus focused light.

Whereas particular embodiments have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims.

What is claimed is:

1. A system, comprising:
a waveguide defining an aperture;
a focusing element having a first refractive index; and
a coupling layer positioned between said waveguide and said focusing element, said coupling layer having a second refractive index that is less than said first refractive index of said focusing element.

2. The system of claim 1, wherein said focusing element is a solid immersion lens.

3. The system of claim 1, wherein said focusing element is a solid immersion mirror.

4. The system of claim 1, wherein said coupling layer comprises at least one of air, MgF₂, Al₂O₃, SiO₂, SiN.

5. The system of claim 1, wherein said coupling layer has a thickness in the range of about 5 nm to about 100 nm.

6. The system of claim 1, wherein the first refractive index of said focusing element is in the range of about 1.7 to about 4.

7. The system of claim 1, wherein said second refractive index of said coupling layer is in the range of about 1.0 to about 2.0.

8. The system of claim 1, further comprising an optical lens positioned in optical communication between an optical energy source and said focusing element.

9. The system of claim 1, wherein said waveguide has an asymmetric charge distribution across said aperture.

10. A system, comprising:
a waveguide including a ridge and defining an aperture through said waveguide;
a focusing element; and
a coupling layer positioned between said waveguide and said focusing element, said coupling layer having a refractive index less than a refractive index of said focusing element.

11. The system of claim 10, wherein said focusing element is a solid immersion lens.

12. The system of claim 10, wherein said focusing element is a solid immersion mirror.

13. The system of claim 10, wherein said coupling layer comprises at least one of air, MgF₂, Al₂O₃, SiO₂, SiN.

14. The system of claim 10, wherein said coupling layer has a thickness in the range of about 5 nm to about 100 nm.

15. A data storage system, comprising:
a storage media;
a recording device positioned adjacent to said storage media, wherein the recording device includes:
a waveguide defining an aperture;
a focusing element having a first refractive index; and
a coupling layer positioned between said waveguide and said focusing element, said coupling layer having a second refractive index that is less than first refractive index of said focusing element.

16. The data storage system of claim 15, wherein said waveguide is a ridge waveguide.

17. The data storage system of claim 15, wherein said focusing element is a solid immersion lens.

18. The data storage system of claim 15, wherein said focusing element is a solid immersion mirror.

19. The data storage system of claim 15, wherein said coupling layer comprises at least one of air, MgF₂, Al₂O₃, SiO₂, SiN.

20. The data storage system of claim 15, wherein said coupling layer has a thickness in the range of about 5 nm to about 100 nm.
